(19) United States
(12) Patent Application Publication
(10) Pub. No.: US 2006/0232627 A1
(43) Pub. Date: Oct. 19, 2006

(54) Power distribution routing to reduce chip area

(75) Inventors: David G. King, Shelbyville, KY (US); George K. Parish, Winchester, KY (US); Kristi M. Rowe, Richmond, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/095,965

(22) Filed: Mar. 31, 2005

(51) Int. Cl. B41J 2/14

(52) U.S. Cl. 347/50

(57) ABSTRACT

An ejector chip (e.g., a heater chip) has at least one fluid (e.g., ink) via, and an elongated actuator (e.g., a resistive heating element) between an edge of the chip and the via. The chip also has a conductive trace connected to the actuator. The chip also has a bondpad central to the length of the actuator to reduce a length of the conductive trace.

### BACKGROUND

Embodiments of the invention relate to printing apparatus, and particularly to ejector chips of the printing apparatus.

Conventional ink jet printers typically include one or more printheads in which ink is stored. Such printheads have one or more ink reservoirs in fluid communication with nozzles through which ink exits the printhead for application to a print medium. In many cases, the nozzles are formed in one or more nozzle plates coupled to a body of the printhead. Each nozzle plate can be or include an ejector chip, such as a heater chip having a set of heat transducers or heaters that function as actuators.

The heater chips also typically include logic circuitry and a plurality of power transistors coupled to the set of heaters or resistors. A hardware or software printer driver will selectively address or energize the logic circuitry via a network of power connections such that appropriate resistors are heated for printing. In some heater chip designs, memory is used to address the resistors. The memory is also used to identify the printhead to determine if the printhead is a monochrome printhead, a color printhead or a photograph quality printer printhead. A thermal ink jet printhead generally includes a network of ejection devices that are generated by joining a heater chip and a nozzle member. When energized, the heater chip heats and vaporizes the ink, thereby ejecting the ink from the nozzles.

### SUMMARY

The actuators (e.g., heaters) on an ejector chip often receive different amounts of energy or power through the network of power connections. This results from differences in the lengths and therefore resistances of the traces connecting the actuators to their respective power sources. This causes the velocity and mass of the ejected drop to vary, and this in turn directly affects the print quality. If the variation from the actuator to actuator is great enough, the addressed actuators may even fail to actuate (e.g., by failing to nucleate or to vaporize the ink droplet).

In order to reduce these differences it is desirable to balance the network delivering energy to the actuators. For example the geometry of conductive traces constituting the network can be adjusted in order to balance and equalize the power supplied to the actuators. In some cases, the network distributing the power to the actuators is divided into two sections. One section is a serial section which runs from a bondpad of the printhead to an end of the actuators. For example, in an ejector chip utilizing heaters as actuators, the serial section might have a small resistance to prevent excessive voltage differences between a single and all fire cases (e.g., less than 0.5 ohms). Meanwhile, the second section of the network is a parallel section which distributes current to a plurality of parallel groups of heaters. The resistance of each of these parallel paths is typically less than 2 ohms.

The amount of current allowed by the bondpads is generally about 1 A. The amount of current is about half of the current required per color under a maximum number of simultaneous fires in some cases. Therefore, two bondpads are generally used for a single color. For example, if the network of heaters has a total of 320 heaters, one of the bondpads can power a first half of the heaters from heater 1 to heater 160, while the other of the bondpads can power a second half of the heaters from heater 161 to heater 320. For a tri-color printhead, a total of six bondpads may be needed. That is, the bondpads can be positioned or placed such that the area of the bondpad required for power routing, and thus the resistance can be reduced or minimized. As a result, the placement or positioning of the bondpads can be considered an important aspect of the design of the printheads.

Other design considerations are that current density is generally kept below a threshold at which electro-migration can occur, and the threshold is about 10 mA/μm². Typically, a trace is at least 100 μm wide for metal approximately 10 k Angstroms (Å) thick in order to carry 1 A of current. Also the resistance of the serial section generally needs to be as small as possible. Depending on the distance between the bondpad and where the network breaks into parallel paths, the width of the series trace will increase to maintain a reasonable resistance.

Once the serial section transitions into the parallel section, the serial section breaks into a number of parallel fingers. Each of the fingers powers a p-group consisting of another number of heaters. Typically, there are eight parallel fingers, and twenty heaters in each of the p-groups. Only one heater at a time fires within the p-group. Furthermore, the parallel fingers are typically arranged vertically a distance away from the serial section. As the distances of successive fingers increase, the p-group will require a wider trace to maintain the same amount of resistance. In some cases, the parallel section is as wide as 430 μm.

Accordingly, there is a need for an improved system and method to balance power distributed to the network of actuators. The following summary sets forth certain embodiments of such methods and systems. However, it does not set forth all such embodiments and should in no way be construed as limiting of any particular embodiment.

Generally, according to an exemplary embodiment of the invention, an ejector chip has an edge, a fluid via, and an elongated actuator, such as a resistive heating element, between the edge and the via. A conductive trace that has a length is connected to the actuator. A bondpad is central to the length of the actuator.

The following summary sets forth certain embodiments of the invention described in greater detail below. It does not set forth all such embodiments and should in no way be construed as limiting of the invention.

Other aspects of the invention will become apparent by consideration of the detailed description and accompanying drawings.

### BRIEF DESCRIPTION OF THE DRAWINGS

FIG. 1 illustrates an ink jet printhead.

FIG. 2 shows a schematic top plan view of a portion of a heater chip.

FIG. 3 shows a cross-section view of the heater chip of FIG. 2.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Embodiments of the invention relate to a method and system of routing power in an ejector chip thereby reducing the size of the chip. The method reduces the width of the power bussing along the vertical edges of the chip. This allows a reduction of the overall chip width.

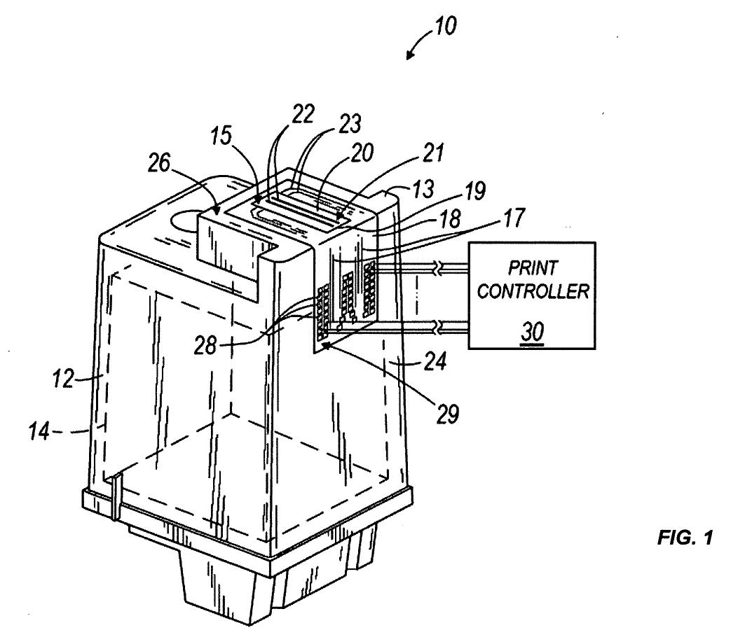

FIG. 1 illustrates an ink jet print head 10 according to one embodiment of the invention. The print head 10 includes a housing 12 that defines a nosepiece 13 and an ink reservoir 14 containing ink or a foam insert saturated with ink. The housing 12 can be constructed of a variety of materials including, without limitation, one or a combination of polymers, metals, ceramics, composites, and the like. The ink jet print head 10 illustrated in FIG. 1 has been inverted to illustrate a nozzle portion 15 of the print head 10. The nozzle portion 15 is located at least partially on a bottom surface 26 of the nosepiece 13 for transferring ink from the ink reservoir 14 onto a print medium not shown. The nozzle portion 15 includes a heater chip 16 not visible in FIG. 1 and a nozzle plate 20 having a plurality of nozzles 22 that define a nozzle arrangement and from which ink drops are ejected onto printing media that is advanced through a printer not shown. The nozzles 22 can have any cross-sectional shape desired including, without limitation, circular, elliptical, square, rectangular, and any other shape that allows ink to be transferred from the print head 10 to a printing medium. The heater chip 16 can be formed of a variety of materials including, without limitation, various forms of doped or non-doped silicon, doped or non-doped germanium, or any other semiconductor material. The heater chip 16 is positioned to be in electrical communication with conductive traces 17 provided on an underside of a tape member 18.

The heater chip 16 is hidden from view in the assembled print head 10 illustrated in FIG. 1. As is commonly known in the art, the heater chip 16 is attached to the nozzle plate 20 in a removed area or cutout portion 19 of the tape member 18. The heater chip 16 is attached such that an outwardly facing surface 21 of the nozzle plate 20 is generally flush with and parallel to an outer surface 29 of the tape member 18 for directing ink onto a printing medium via the plurality of nozzles 22 in fluid communication with the ink reservoir 14. Although a thermal ink jet printing apparatus is used in the example, other types of ink jet technology such as piezoelectric technology can also be used with the invention.

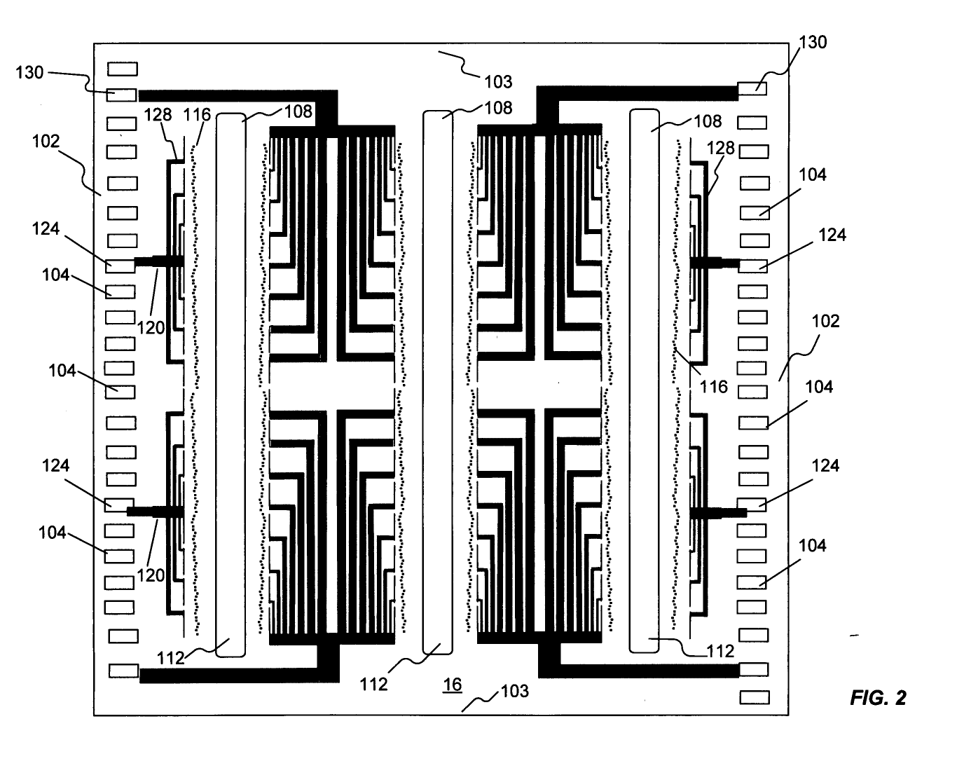

FIG. 2 shows a schematic top plan view of a portion of the heater chip 16 according to an embodiment of the invention. The heater chip 16 has a plurality of edges 102, 103. An array of bondpads 104 is attached or positioned along each of the edges 102. A plurality of ink vias 108 are also formed on the heater chip 16. Although three ink vias 108 are shown in FIG. 2, the heater chip 16 can also have other numbers of ink vias 108. Each of the ink vias 108 has an end portion 112.

The heater chip 16 also includes an elongated actuator, such as resistive heating element 116, positioned on the heater chip 16 between the edge 102 and the ink via 108. The elongated resistive heating element 116 usually includes an array of heater resistors. In some embodiments, each of the heater resistors of the elongated resistive heating element 116 can be individually actuated, addressed, activated, or powered.

A conductive trace 120 is positioned between the resistive elements 116 and the bondpad array 104. In the embodiment shown in FIG. 2, the conductive trace 120 connects a first designated bondpad 124 of the bondpad array 104 to the resistive element 116. The first designated bondpad 124 is generally positioned central to the length of the resistive element 116. In some embodiments, the first designated bondpad 124 is positioned directly opposite the middle of the resistive element that the conductive trace 120 powers. For example, if one array of the resistive elements 116 includes 320 heaters or heater resistors, the first designated bondpad 124 that heats or powers the first 160 heaters or heater resistors can be located just opposite the middle of the 160 heater resistors, or the 80^{th} heater resistor.

The conductive trace 120 has a plurality of fingers or traces 128. Each of the fingers of the conductive trace 120 powers a specific set of heater resistors. In the example discussed earlier, a first finger 128 powers the first 20 heater resistors. In some embodiments, each of the heater resistors of the resistive elements 116 can also be powered individually. That is, the bondpad 124 can be configured to address or heat none, some or all of the heaters at a particular time.

For the resistive elements 116 that are positioned between any two adjacent ink vias 108, a second designated bondpad 130 is positioned outside the length of the ink vias 108 in a longitudinal axis. In this way, the distance between the first designated bondpad 124 and the resistive elements 116, or the length of the conductive trace 120 can be reduced or minimized. The arrangement of the conductive trace 120 also allows the width of the trace to be small for given resistance. In some embodiments, the arrangement of the conductive trace 120 also allows the width of the trace to be the smallest for a given resistance.

Attaching, positioning, or placing the first designated bondpad 124 in the middle of the array of heater resistors 116, or the second designated bondpad 130 outside the length of the ink vias 108 can reduce the width of the parallel sections of a conductive trace. By placing first designated bondpad 124 in the middle, and the second designated bondpad 130 outside the length of the ink vias 108, the distance between the bondpad array 104 or the edge 102, and the elongated resistive elements 116 is also minimized. In the embodiment shown in FIG. 2, the conductive trace 120 spreads into two sets of four fingers running in opposite directions towards the opposite end portions 112. To maintain a same resistance for each of the fingers, the two sets of four fingers require a width of about 150 μm to provide the same resistance to each of the resistive elements 116. The arrangement of the bondpad array 104 and the conductive trace 120 thus can provide a reduction of 280 μm on each side of the heater chip 16, in some embodiments. If both sides of the heater chip 16 are populated, the heater chip 16 can have a size reduction of 560 μm on the width.

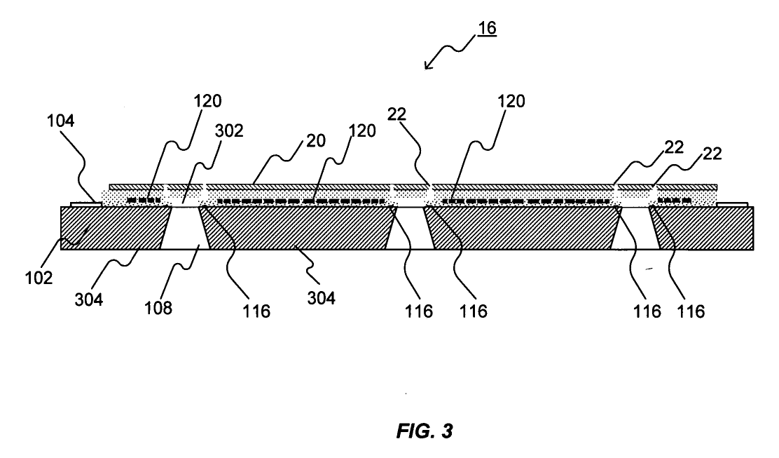

FIG. 3 shows a cross-sectional view of the heater chip 16 shown in FIG. 2. The cross-sectional view shows a plurality of nozzles 22 populated on a nozzle plate 20. Underneath the nozzle plate 20 is the conductive trace 120 positioned adjacent a plurality of openings 302 of the ink vias 108. As shown in FIG. 3, the bondpad arrays 104 are also positioned adjacent the conductive traces 120 that are positioned adjacent the edges 102. The resistive elements 116 are also shown as being positioned adjacent the opening of each of the ink vias 108 and the conductive traces 120. Beneath the conductive traces 120 and around the ink vias 108 is a heater chip substrate 304.

Various features and advantages of the invention are set forth in the following claims.

What is claimed is:

1. An ejector chip comprising:
an edge;
a fluid via;
an elongated actuator between the edge and the via;
a conductive trace connected to the actuator and having a length and a width; and
a bondpad central to the length of the actuator to reduce at least one of the width and the length of the conductive trace.

2. The chip of claim 1, wherein the elongated actuator comprises an array of heater resistors and the fluid via comprises an ink via.

3. The chip of claim 2, wherein each of the heater resistors is individually addressable.

4. The chip of claim 2, wherein the array of the heater resistors is powered via at least one of the bondpad and the conductive trace.

5. The chip of claim 1, wherein the chip further comprises a second fluid via adjacent the first via, a second elongated actuator between the first via and the second via, a second conductive trace connected to the second actuator and having a length, and a second bondpad outside the length of first and the second vias to reduce the length of the second conductive trace.

6. The heater chip of claim 5, wherein the second bondpad is positioned such that the width of the second conductive trace is minimized.

7. The chip of claim 1, wherein the conductive trace comprises a plurality of fingers, each finger operable to power a portion of the elongated actuator.

8. A heater chip comprising:
a plurality of ink vias;
a first array of heater resistors between adjacent ones of the ink vias;
a first conductive trace connected to the first array and having a width and a length;
a first bondpad along an edge of the chip and outside the length of the adjacent ones of the vias to reduce at least one of the width and the length of the first conductive trace;
a second array of heater resistors between the edge of the chip and one of the ink vias near the edge of the chip;
a second conductive trace connected to the second array and having a length; and
a second bondpad along the edge of the chip and central to the length of the second array to minimize the length of the second conductive trace.

9. The heater chip of claim 8, wherein the second bondpad is positioned such that the width of the second conductive trace is minimized.

10. The heater chip of claim 8, wherein the second conductive trace comprises a plurality of fingers, each finger operable to power a portion of the first array.

11. An ink jet print cartridge comprising:
an ejector chip having an edge;
an ink via in the chip;
an elongated actuator positioned on the chip between the edge and the ink via;
a conductive trace connected to the resistive heating element and having a length and a width; and
a bondpad positioned on the chip central to the length of the actuator to reduce at least one of the width and the length of the conductive trace.

12. The ink jet print cartridge of claim 11, wherein the elongated actuator comprises an array of heater resistors.

13. The ink jet print cartridge of claim 12, wherein each of the heater resistors is individually addressable.

14. The ink jet print cartridge of claim 12, wherein the array of the heater resistors is powered via at least one of the bondpad and the conductive trace.

15. The ink jet print cartridge of claim 11, wherein the ejector chip further comprises a second ink via in the chip adjacent the first ink via, a second elongated actuator positioned on the chip between the first ink via and the second ink via, a second conductive trace connected to the second actuator and having a length, and a second bondpad positioned on the chip outside the length of first and the second ink vias to reduce the length of the second conductive trace.

16. The ink jet print cartridge of claim 15, wherein the second bondpad is positioned on the chip such that the width of the second conductive trace is minimized.

17. The ink jet print cartridge of claim 11, wherein the conductive trace comprises a plurality of fingers, each finger operable to power a portion of the elongated actuator.
